(19) United States
(12) Patent Application Publication
(10) Pub. No.: US 2024/0319519 A1
(43) Pub. Date: Sep. 26, 2024

(54) EYEGLASSES STRUCTURE

(71) Applicant: RUSAN OPTICAL INDUSTRIAL CO., LTD., Taipei City (TW)

(72) Inventor: Yi-Hua WU, Taipei City (TW)

(21) Appl. No.: 18/126,404

(22) Filed: Mar. 25, 2023

(51) Int. Cl. G02C 5/22; G02C 5/20

(52) U.S. Cl. CPC G02C 5/2254; G02C 5/20; G02C 2200/04; G02C 2200/06

(57) ABSTRACT

An eyeglass's structure includes a frame, a connecting seat, and a buckle. The frame includes a connection part formed on two sides of the frame separately; the connecting seat corresponding to the connection part has a sliding slot selectively situated in a lock or unlock position; and the buckle is slidably installed in the sliding slot and includes two elastic arms connected to each other and an end pivoted to the connection part. When the buckle is in the lock position, each elastic arm is bound by the sliding slot. When the buckle is in the unlock position, each elastic arm can be elastically deformed by external forces to detach the connection part, so as to achieve the effect of disassembling or assembling the frame quickly.

### BACKGROUND OF THE DISCLOSURE

### Technical Field

The technical field relates to eyeglasses, and more particularly relates to an eyeglasses structure with a frame that may be disassembled or assembled quickly.

### Description of Related Art

Eyeglasses are widely used in daily life, and an eyeglasses structure is usually hinged to the temples on two sides of the frame by bolts, so that it is not only necessary to use screwdriver or other tools to assemble or disassemble the eyeglasses, but also takes a lot of time to tighten or loosen the bolts, and there is also a risk of accidentally losing or missing the bolts during the assembling or disassembling process. In addition, users often take off the eyeglasses when resting, so that the temples need to pivot relative to the frame frequently, thus resulting in loosened bolts or detached temples after a long time of use. Therefore, how to design an eyeglasses structure with a frame that can be quickly and easily disassembled and a pair of durable temples demands immediate attention and feasible solutions.

In view of the aforementioned problem, the discloser proposed this disclosure based on his expert knowledge and elaborated researches to overcome the problem of the related art.

### SUMMARY OF THE DISCLOSURE

It is a primary objective of this disclosure to provide an eyeglasses structure with a frame that can be disassembled or assembled quickly.

To achieve the aforementioned and other objectives, this disclosure discloses an eyeglasses structure including a frame, a pair of connecting seats, a pair of buckles and a pair of temples, two connection parts are separately disposed on two sides of the frame separately, each connection part includes a first hinge structure, two connecting seats are arranged corresponding to the connection parts respectively, each connecting seat includes a sliding slot including a lock position or an unlock position, the buckles are slidably installed in the two sliding slots respectively, each buckle includes a pair of elastic arms, a front end of one elastic arm is connected to a front end of another elastic arm, a second hinge structure is disposed on a distal end of the elastic arm, each second hinge structure of each buckle is pivoted to the first hinge structure of the connection part correspondingly, and each temple is installed to the connecting seat correspondingly. When the buckle is situated in the lock position, each elastic arm is bound by each sliding slot; and when the buckle is situated in the unlock position, each elastic arm is elastically deformed by an external force to make the second hinge structure be detached from the first hinge structure correspondingly.

In an embodiment of this disclosure, each first hinge structure includes a through hole, each second hinge structure of each buckle includes two cylinders facing each other, and the cylinders of each buckle are buckled and pivoted to two sides of the through hole respectively.

In an embodiment of this disclosure, each buckle includes a rod body, the rod body is extended from a joint of the pair of elastic arms, each sliding slot includes an open section and a close section which are connected to each other, and the open section of each connecting seat is arranged to be facing each connection part correspondingly and accommodating each elastic arm correspondingly, and the close section of each connecting seat is arranged to be facing each temple correspondingly and accommodating the rod body.

In an embodiment of this disclosure, a shape of an inner edge of each open section is matched with a shape of an outer edge of each elastic arm accommodated in the open section.

In an embodiment of this disclosure, the rod body includes a stopper disposed on a distal end thereof, the close section includes a stop surface disposed on a side facing the open section, and when each buckle is situated in the unlock position, the stopper is latched to the stop surface to limit the buckle.

In an embodiment of this disclosure, each temple includes a cover plate attached to a side of each connecting seat disposed with each sliding slot to limit the rod body in each sliding slot.

In an embodiment of this disclosure, each connecting seat includes a limiting beam, and the limiting beam of each connecting seat straddles each sliding slot to limit each elastic arm in each sliding slot.

In an embodiment of this disclosure, each temple includes a positioning post, each connecting seat includes a positioning hole, and the positioning post of each temple passes through the positioning hole correspondingly.

In an embodiment of this disclosure, each buckle includes an abutting surface disposed on a joint of the pair of elastic arms, and when the buckle is situated in the unlock position, the abutting surface abuts against the positioning post to stop the buckle.

In an embodiment of this disclosure, the temples are disposed pivotally on the connecting seats respectively, each temple includes a latch, each connecting seat includes a plurality of positioning slots arranged equiangularly, and the latch of each temple is selectively snapped in one of the positioning slots.

The eyeglasses structure of this disclosure is pivoted to the first hinge structure through each second hinge structure, so that the temples connected to the connecting seats may pivot relative to the frame, while the buckle may slide to the unlock position through the sliding slot, and an external force may be applied to elastically deform the elastic arm to detach the second hinge structure from the corresponding first hinge structure, so as to achieve the effect of assembling or disassembling the frame quickly.

### BRIEF DESCRIPTION OF THE DRAWINGS

FIG. 1 is a perspective view of this disclosure;

FIG. 2 is an exploded view of this disclosure;

FIG. 3 is a cross-sectional view of a buckle of this disclosure, situated in a lock position;

FIG. 4 is a cross-sectional view of a buckle of this disclosure, situated in an unlock position;

FIG. 5 is a cross-sectional view showing the status of use of a disassembled frame of this disclosure; and

FIG. 6 is a cross-sectional view of this disclosure.

### DETAILED DESCRIPTION

In the description of this disclosure, it should be understood that the terms “front”, “rear”, “left”, “right”, “front end”, “rear end”, “end”, “longitudinally”, “transversally”, “vertical”, “top”, “bottom”, etc. refer to an indicated orientation and a positional relation based on the orientation and positional relation as shown in the attached drawings. These terms are used for the purpose of describing the creation of this disclosure and simplifying the description, but not intended for indicating or implying that the device or component must have the specific position, the specific positional structure and operation, so that these terms should not be construed as a limitation on this disclosure.

In the description of this disclosure, the terms such as “first”, “second”, “third”, “fourth”, “fifth”, etc. are used for describing various elements, components, areas, layers, and/or parts, and these elements, components, areas, layers and/or parts should not be limited by these terms, and these terms are used for simplifying the description only, but should not be understood as indicating or implying the relative importance or the quantity of the technical characteristics as implied or indicated.

The technical contents of this disclosure will become apparent with the detailed description of embodiments accompanied with the illustration of related drawings as follows. It is intended that the embodiments and drawings disclosed herein are to be considered illustrative rather than restrictive.

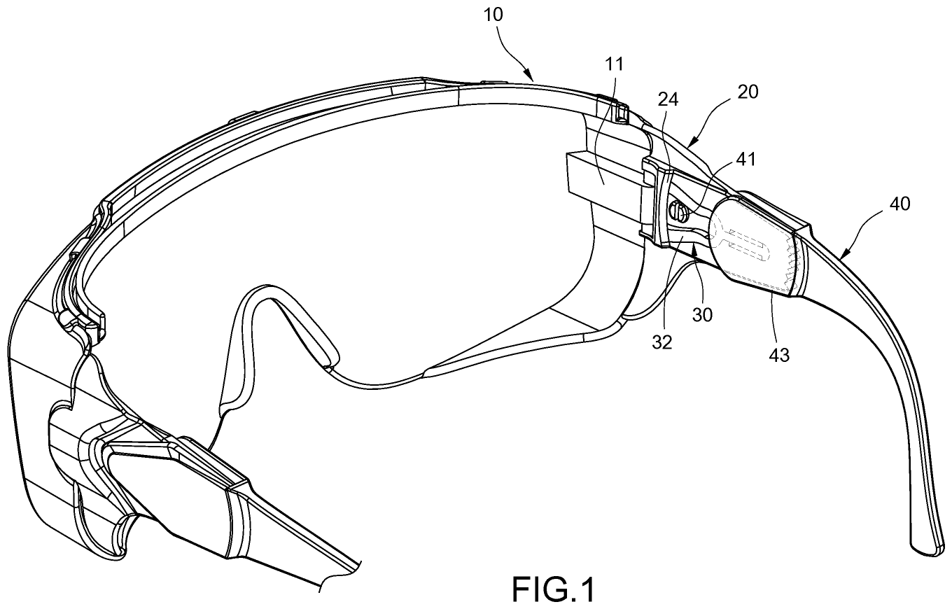

With reference to FIGS. 1 to 4 for an eyeglasses structure of this disclosure, the eyeglasses structure includes a frame 10, a pair of connecting seats 20, a pair of buckles 30 and a pair of temples 40.

In this embodiment, the frame 10 is integrally formed (or formed in one piece) by two lenses (not labeled in the figures), but this disclosure is not limited to thereto, for example, each lens may also be detachably mounted on the frame 10. A connection part 11 is formed on the left and right sides of the frame 10 separately. In this embodiment, the connection part 11 is in the shape of a rectangular column, but this disclosure is not limited to thereto, for example, the connection part 11 may be in any shape, as long as it is matched with the connecting seat 20 and the buckle 30. Each connection part 11 has a first hinge structure 111. Specifically, as shown in FIG. 1, the first hinge structure 111 is disposed at one end of the corresponding connection part 11 to facilitate the installation of the connecting seat 20 and the buckle 30, but this disclosure is not limited thereto.

In this embodiment, the connecting seat 20 is integrally formed (or formed in one piece) by plastic injection molding, but this disclosure is not limited thereto. The connecting seats 20 are arranged corresponding to the connection parts 11 respectively. Specifically, the front end of each connecting seat 20 is arranged corresponding to the rear end of the outer side of each connection part 11 as shown in FIG. 1. The inner of each connecting seat 20 has a sliding slot 21, that is, the sliding slot 21 and the corresponding connection part 11 are on the same side of the connecting seat. In this embodiment, the first hinge structure 111 at one end of the connection part 11 is accommodated in the sliding slot 21, so that the connecting seat 20 may fit closely with the frame 10, but this disclosure is not limited thereto. Each sliding slot 21 includes a lock position 21A and an unlock position 21B.

Each buckle 30 is slidably installed in each corresponding sliding slot 21, so that the buckle 30 may slide between the lock position 21A and the unlock position 21B in the sliding slot 21. In this embodiment, the buckle 30 is integrally formed (or formed in one piece) by plastic injection molding, but this disclosure is not limited thereto. In this embodiment, each buckle 30 is substantially Y-shaped. Specifically, each buckle 30 of this embodiment includes a rod body 31 and a pair of elastic arms 32. The front end of each elastic arm 32 is connected to the corresponding front end of another elastic arm 32. Each rod body 31 separately extends in opposite directions from the joint of the corresponding pair of elastic arms 32, so that the rod bodies 31 are a substantially Y-shaped structure. However, the shape of the buckle 30 in this disclosure is not limited thereto, for example, each buckle 30 may only include a pair of elastic arms 32 which are a substantially C-shaped structure.

A second hinge structure 321 is disposed at one end of each elastic arm 32. The second hinge structure 321 of each buckle 30 is pivotally connected to the corresponding first hinge structure 111 of the connection part 11. In this embodiment, the first hinge structure 111 of each connection part 11 is a through hole, and the second hinge structure 321 of each buckle 30 is a cylinder, and the two are arranged to be facing each other. In other words, each cylinder is separately disposed on opposite inner sides of each elastic arm 32, so that the buckle 30 may make the cylinder pivotally buckle to two ends of the corresponding through hole separately through the elastic arm 32, but this disclosure is not limited thereto, for example, the first hinge structure 111 may also be a cylinder arranged on the upper and lower sides of the connection part 11 separately, and each second hinge structure 321 is a round hole.

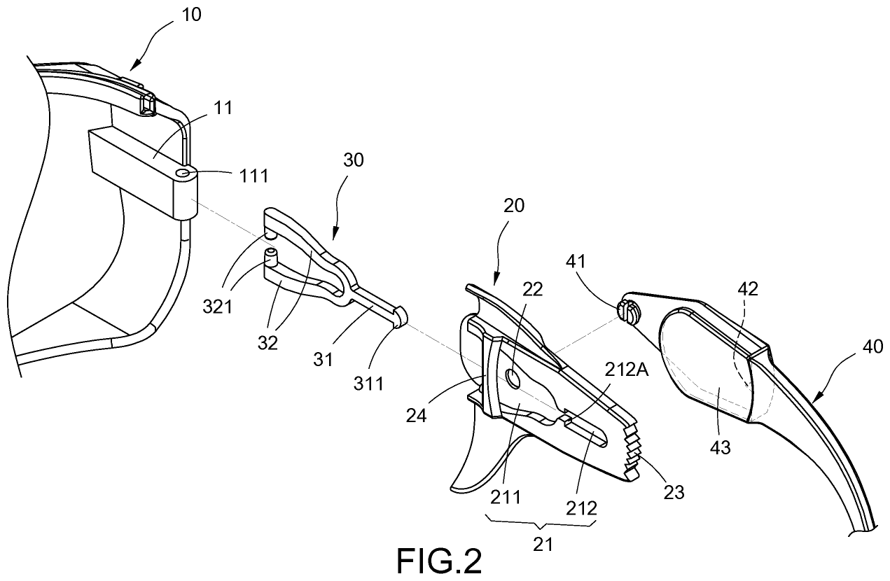

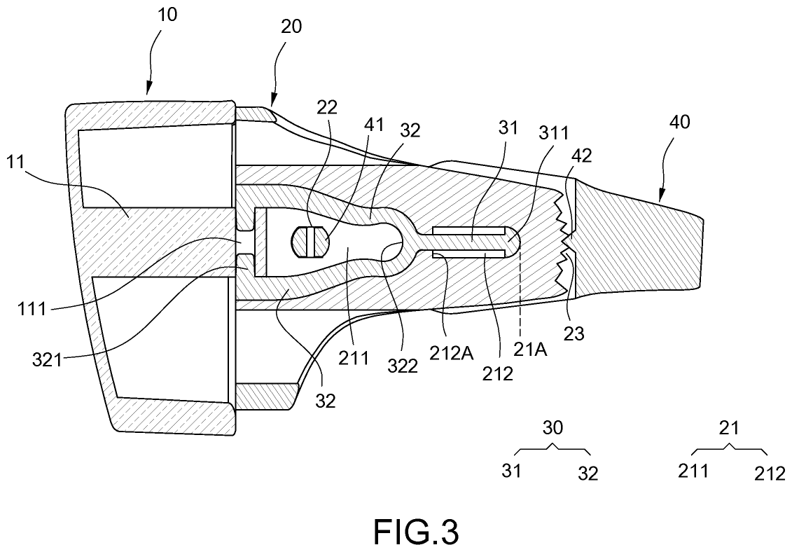

Each temple 40 is arranged on each connecting seat 20. Specifically, each temple 40 of this embodiment has a positioning post 41, and each connecting seat 20 has a positioning hole 22. The positioning post 41 of each temple 40 passes through and is connected to the corresponding positioning hole 22, but this disclosure is not limited thereto, for example, the temple 40 and the connecting seat 20 may also be connected by screw connection, snap-in connection, buckle connection, riveted connection, lamination, or integral formation. In this embodiment, each temple 40 is pivoted to each corresponding connecting seat 20. In other words, the temple 40 may pivot relative to the connecting seat 20 through the rotation of the positioning post 41 and the positioning hole 22, so that a user may adjust the hanging angle of the temple 40 when wearing the eyeglasses, but this disclosure is not limited thereto. For example, the temple 40 may also be fixed on the connecting seat 20 directly. In FIGS. 2 and 3, each temple 40 has a latch 42, and each connecting seat 20 has a plurality of positioning slots 23. In this embodiment, the latch 42 is a triangular bump, and each positioning slot 23 is a triangular groove corresponding to the latch 42, but this disclosure is not limited thereto. Each positioning slot 23 is arranged at an equal angle around the positioning hole 22. The latch 42 of each temple 40 may be selectively snapped into one of the positioning slots 23, so that the temple 40 is fixed at a desired angular position after pivoting.

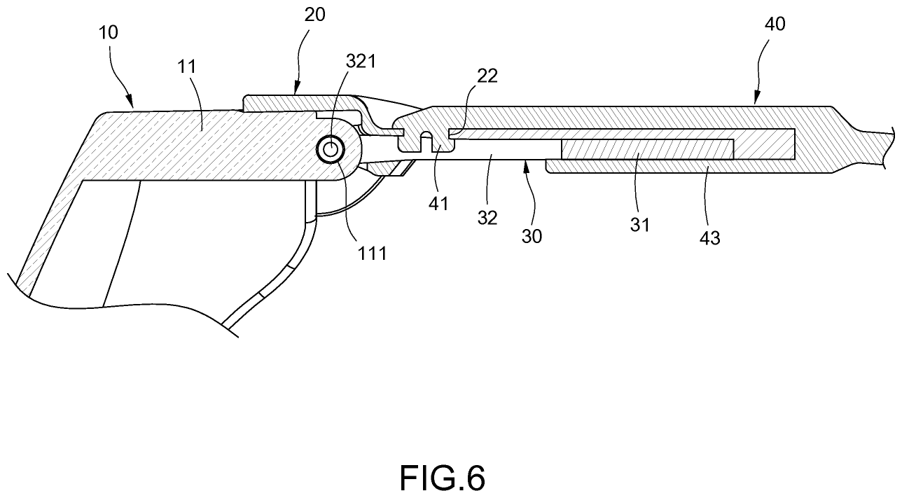

It is noteworthy that, as shown in FIGS. 2 to 6, each positioning post 41 of this embodiment is structured by two semicircular cylinders (not labeled in the figures) arranged opposite to each other, and there is a gap (not labeled in the figures) between the two semicircular cylinders. In this way, when the user adjusts the temple 40, the user may first pull the temple 40 backward, so that the semicircular cylinder adjacent to each positioning slot 23 collapses toward another semicircular cylinder to eliminate the aforementioned gap, so that the temple 40 may not be interfered, deformed, or structurally damaged, and the latch 42 may be detached from the original positioning slot 23 easily to facilitate the user to rotate and adjust the temple 40.

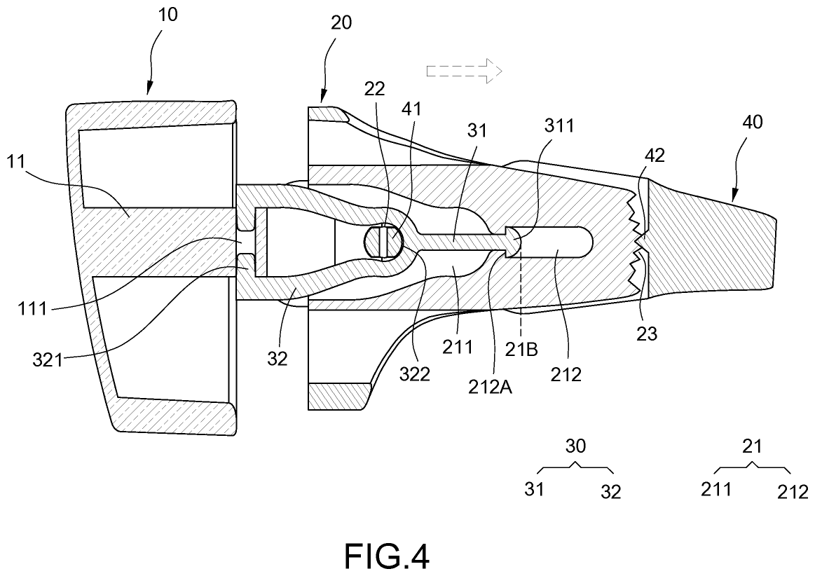

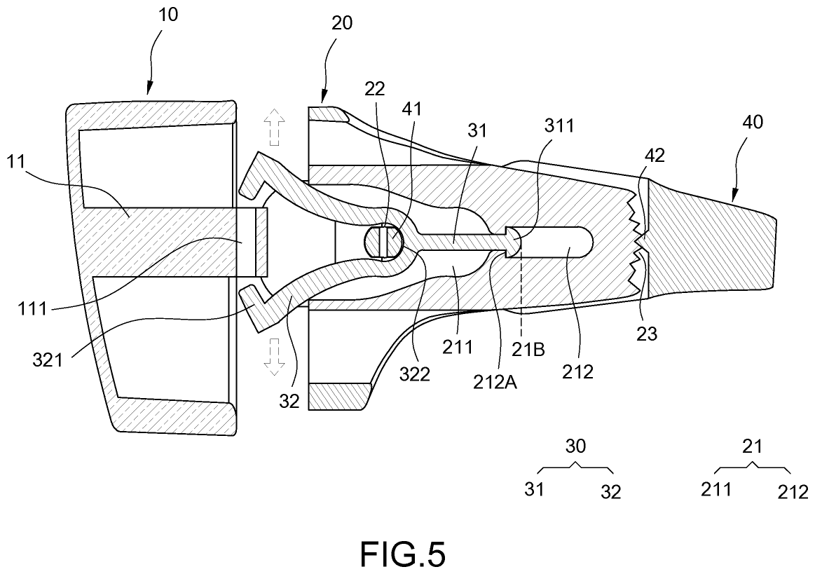

In FIG. 3, when each buckle 30 slides to the lock position 21A, each elastic arm 32 is bound by the sliding slot 21, so that each second hinge structure 321 is securely fastened to the first hinge structure 111. In FIGS. 4 and 5, when the temple 40 is pulled to drive the connecting seat 20 to slide each buckle 30 to the unlock position 21B, the user may apply an external force to elastically deform the elastic arm 32, so that each second hinge structure 321 is detached from the first hinge structure 111 to dissemble the frame 10. It is noteworthy that when it is necessary to assemble the frame 10 with each connecting seat 20, each buckle 30 and each temple 40, it is also necessary to pull each buckle 30 to the unlock position 21B, and pull each elastic arm 32 outward to hinge each second hinge structure 321 to the corresponding first hinge structure 111, and then slide the buckle 30 to the lock position 21A. In this way, the eyeglasses structure of this disclosure may disassemble or assemble the frame 10 quickly to achieve a convenient replacement effect.

In FIGS. 2 and 3, each sliding slot 21 includes an open section 211 and a close section 212 which are connected to each other. Specifically, the open section 211 of each connecting seat 20 is arranged to be facing the corresponding connection part 11 and provided for accommodating each corresponding elastic arm 32, and the close section 212 of each connecting seat 20 is arranged to be facing the corresponding temple 40 and provided for accommodating the corresponding rod body 31. In addition, the shape of the inner edge of each open section 211 matches the shape of the outer edge of the corresponding elastic arm 32. In this embodiment, the inner edge of each open section 211 is in the shape of a bowling pin (in a shape with a rounded portion and a bulged portions connected by a narrowed portion). Specifically, the inner edge of the open section 211 in the shape of a bowling pin allows the outer edge of each elastic arm 32 to attach to the inner edge of the open section 211 closely when the buckle 30 is situated in the lock position 21A, so that the elastic arm 32 may be fixed and bound. The inner edge of the open section 211 of this disclosure is not limited thereto, for example, the inner edge of the open section 211 may also be C-shaped, which may also achieve the effect of fixing and binding the outer edge of each elastic arm 32.

In FIGS. 3 and 4, the eyeglasses structure of this disclosure also designs a stop structure to limit the sliding stroke of each buckle 30 relative to each corresponding connecting seat 20. Specifically, an end of each rod body 31 away from each elastic arm 32 is provided with a stopper 311, and a side of each close section 212 facing the corresponding open section 211 is formed with a stop surface 212A. In this way, when each buckle 30 slides to the unlock position 21B, the stopper 311 is snapped into the stop surface 212A to limit the buckle 30 to continue sliding, so as to prevent the buckle 30 from detaching from the sliding slot 21. In this embodiment, the stopper 311 is in a hook shape (arrow-like shape), but this disclosure is not limited thereto. For example, the stopper 311 may be a rectangular bump or a round bump as long as it may be snapped into the stop surface 212A, and the shape of the stop surface 212A may be adjusted to match the shape of the corresponding stopper 311. In addition, the joint of each buckle 30 at each elastic arm 32 is formed with an abutting surface 322. In other words, the abutting surface 322 is disposed between the elastic arms 32 and proximate to the rod body 31. In this way, when each buckle 30 slides to the unlock position 21B, the abutting surface 322 abuts against the positioning post 41 to stop the buckle 30 and prevent it from sliding continuously, so as to prevent the buckle 30 from detaching from the sliding slot 21. It is noteworthy that this disclosure is not limited to the requirement of installing both the stopper 311 and the abutting surface 322 at the same time, but it is also possible to install one of the two to achieve the effect of limiting the buckle 30 to continue sliding.

In FIGS. 1, 2 and 6, the eyeglasses structure of this disclosure further designs a limiting structure to ensure that each buckle 30 remains accommodated in sliding slot 21 and may not be separated from an inner side of the connecting seat 20 during the sliding process. Specifically, each temple has a cover plate 43. Each cover plate 43 is attached to a side of each corresponding connecting seat 20 having the sliding slot 21, and each rod body 31 is limited in the close section 212 of the sliding slot 21. In other words, the temple 40 covers the two sides of the rear end of the connecting seat 20 through the cover plate 43. Since the stopper 311 of each rod body 31 is snapped into each corresponding stop surface 212A, each rod body 31 may be limited completely within each close section 212 and may not be detached. In addition, each connecting seat 20 has a limiting beam 24 arranged across the corresponding sliding slot 21 to limit each corresponding elastic arm 32 in the sliding slot 21. In this way, the rod body 31 and the elastic arm 32 may be limited in the sliding slot 21 and may not be separated from each other by means of the cover plate 43 and the limiting beam 24, but this disclosure is not limited to the requirement of installing both the cover plate 43 and the limiting beam 24 at the same time, and it is also possible to install one of the two to achieve the effect of limiting the buckle 30 from detaching from the sliding slot 21 of the connecting seat 20.

In the eyeglasses structure of this disclosure, each second hinge structure 321 of the buckle 30 is buckled and pivoted to the first hinge structure 111 of the frame 10, so that the temple 40 connected to the connecting seat 20 may pivot relative to the frame 10, the buckle 30 may slide to the unlock position 21B through the sliding slot 21 of the connecting seat 20, and an external force may be applied to elastically deform the pair of elastic arms 32 to detach each second hinge structure 321 from the corresponding first hinge structure 111, so as to achieve the effect of disassembling or assembling the frame 10 quickly.

While this disclosure has been described by means of specific embodiments, numerous modifications and variations could be made thereto by those skilled in the art without departing from the scope and spirit of this disclosure set forth in the claims.

What is claimed is:

1. An eyeglass's structure, comprising:
a frame, comprising two connection parts separately disposed on two sides thereof, and each connection part comprising a first hinge structure;
a pair of connecting seats, arranged corresponding to the connection parts respectively, each connecting seat comprising a sliding slot, and each of the sliding slots comprising a lock position and an unlock position;
a pair of buckles, slidably installed in two sliding slots respectively, each buckle comprising a pair of elastic arms, a front end of one elastic arm coupled to a front end of another elastic arm, each elastic arm comprising a second hinge structure disposed on a distal end thereof, and the second hinge structure of each buckle pivotally coupled to the first hinge structure of the connection part correspondingly; and
a pair of temples, installed to the connecting seats respectively;
wherein, when each buckle is situated in the lock position, each elastic arm is bound by each sliding slot, and when each buckle is situated in the unlock position, each elastic arms is elastically deformed by an external force to make each second hinge structure be detached from the first hinge structure correspondingly.

2. The eyeglasses structure according to claim 1, wherein each first hinge structure comprises a through hole, each second hinge structure of each buckle comprises two cylinders facing each other, and the cylinders of each buckle are buckled and pivoted to two sides of the through hole respectively.

3. The eyeglasses structure according to claim 1, wherein each buckle further comprises a rod body, the rod body is extended from a joint of the pair of elastic arms, each sliding slot comprises an open section and a close section coupled to each other, the open section of each connecting seat is arranged to be facing each connection part correspondingly and accommodating each elastic arm correspondingly, and the close section of each connecting seat is arranged to be facing each temple correspondingly and accommodating the rod body.

4. The eyeglasses structure according to claim 3, wherein a shape of an inner edge of each open section is matched with a shape of an outer edge of each elastic arm accommodated in the open section.

5. The eyeglasses structure according to claim 3, wherein the rod body comprises a stopper disposed on a distal end thereof, the close section comprises a stop surface disposed on a side facing the open section, and when each buckle is situated in the unlock position, the stopper is latched to the stop surface to limit the buckle.

6. The eyeglasses structure according to claim 3, wherein each temple comprises a cover plate attached to a side of each connecting seat disposed with each sliding slot to limit the rod body in each sliding slot.

7. The eyeglasses structure according to claim 3, wherein each connecting seat comprises a limiting beam, and the limiting beam of each connecting seat straddles each sliding slot to limit each elastic arm in each sliding slot.

8. The eyeglasses structure according to claim 1, wherein each temple comprises a positioning post, each connecting seat comprises a positioning hole, and the positioning post of each temple passes through the positioning hole correspondingly.

9. The eyeglasses structure according to claim 8, wherein each buckle comprises an abutting surface disposed on a joint of the pair of elastic arms, and when each buckle is situated in the unlock position, the abutting surface abuts against the positioning post to stop the buckle.

10. The eyeglasses structure according to claim 1, wherein the temples are disposed pivotally on the connecting seats respectively, each temple comprises a latch, each connecting seat comprises a plurality of positioning slots arranged equiangularly, and the latch of each temple is selectively snapped in one of the positioning slots.
